(19) United States
(12) Patent Application Publication
(10) Pub. No.: US 2001/0048088 A1
(43) Pub. Date: Dec. 6, 2001

(54) MICROCHIP-BASED PRECISION FLUID HANDLING SYSTEM

(76) Inventors: DENNIS L. POLLA, ROSEVILLE, MN (US); RONALD C. MCGLENNEN, EDINA, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 09/230,915

(22) PCT Filed: Jul. 24, 1998
(86) PCT No.: PCT/US98/15463

§ 371 Date: None

(51) Int. Cl. F16K 31/02

(52) U.S. Cl. 251/129.06; 417/418; 251/11

(57) ABSTRACT

A precision controller of the movement of at least a first fluid, includes a precision motor. Valve apparatus is operably coupled to the precision motor. Orifice apparatus is fluidly coupled to a source of fluid and to the valve apparatus, whereby actuation of the valve apparatus by the precision motor acts to selectively expose and cover the orifice to implement fluid valving.

### RELATED APPLICATIONS

The present application claims the benefit of U.S. Provisional Application No. 60/053,611, filed Jul. 24, 1997.

### TECHNICAL FIELD

The subject of this application relates to devices and methods having the ability to precisely control the movement of fluids by using (1) precision micromotors, (2) chip fabrication technologies, (3) precision machining methods.

### SUMMARY OF THE INVENTION

The microfluidic control system of the present invention comprises a wide range of applications, including (1) the control of chemical reagents as needed for certain clinical diagnostic tests, (2) the control delivery of drugs and other medications, both in and external to the body, (3) hydraulic systems, (4) medical surgical applications, (5) combustion control and (6) other applications where small amounts of liquid or gases are needed to be precisely delivered and metered. The subject of this invention also relates to the use of microfabricated valves, pumps, and capillaries formed by applications of common integrated circuit processing methods.

The present invention is a precision controller of the movement of at least a first fluid. The precision controller includes a precision motor. Valve apparatus is operably coupled to the precision motor. Orifice apparatus is fluidly coupled to a source of fluid and to the valve apparatus, whereby actuation of the valve apparatus by the precision motor acts to selectively expose and cover the orifice to implement fluid valving.

### BRIEF DESCRIPTION OF THE DRAWINGS

FIG. 1. Precision motor/actuator driven shutter with electrostatic clamping in either open, partially-restricted, or closed position.

FIG. 2. Precision motor/actuator connected to a microfabricated capillary. All components are fabricated on a single semiconductor substrate.

FIG. 3. Precision fluid delivery through a microfabricated capillary

FIG. 4. Microfabricated check valve integrated with a capillary and plunger.

### DETAILED DESCRIPTION OF THE DRAWINGS

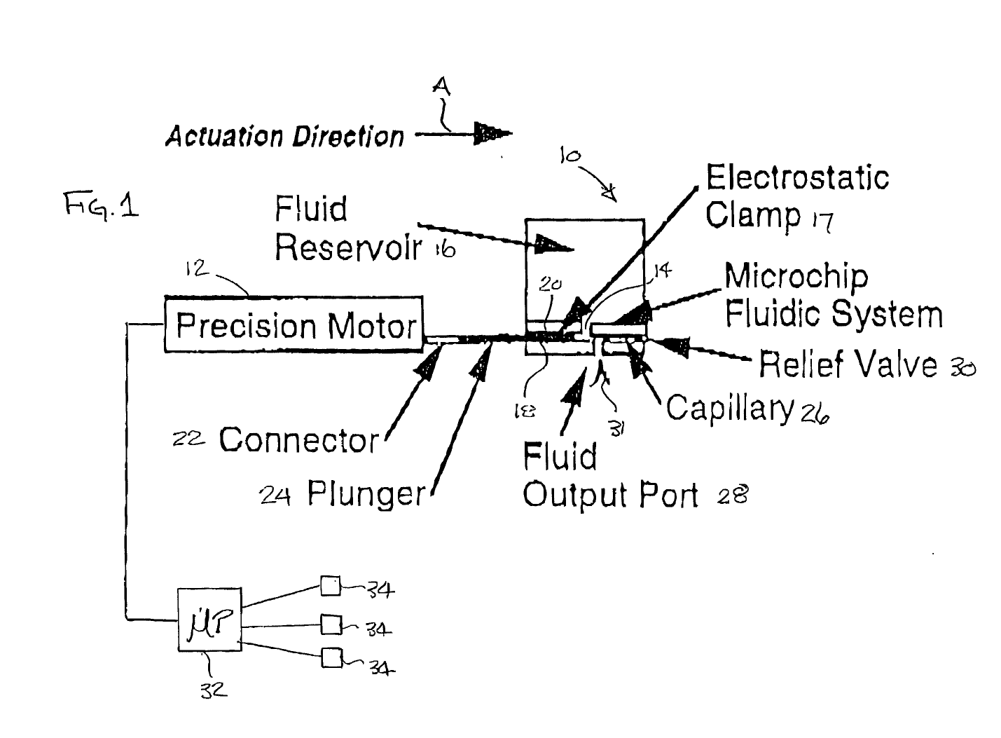

The first technical approach of this disclosure is shown in FIG. 1. The fluid handling system of the present invention is depicted generally at 10. Like numbers are used to designate like components throughout. A precision or variable displacement linear stepper motor 12 is used to expose or cover an appropriate fluidic orifice 14 to implement fluid valving of the reservoir 16. An electrostatic clamp 17 providing electrostatic clamping of silicon or silicon-compatible surfaces is used to firmly immobilize the valve seat 18 to shut-off, restrict, or allow fluid passage from the reservoir 16 through fluid output port 22 while the precision actuator 12 is not moving. This clamping effect allows for a tight seal of the valve 20. The stationary position of the precision actuator 12 and the immobilized valve seat 18 insure that appropriate and reliable fluid metering can be accomplished by the valve 20.

The valve 20 is coupled to the motor 12 by a suitable connector 22. The connector 22 is coupled, preferably in a linear manner, to a plunger 24. The plunger 24 is translatably disposed in a microfabricated capillary 26. The capillary 26 is fluidly coupled to the orifice 14. The capillary 26 is also fluidly coupled to an output port 28. The capillary 26 is closed at an end by a relief valve 30.

When the plunger 24 is in a retraced disposition, as depicted in FIG. 1, fluid 31 is free to flow from the reservoir 16 through the orifice 14 and a portion of the capillary 26 and be delivered through the output port 28. Translation of the plunger 24 to the right within the capillary 26, as depicted in FIG. 1, as indicated by the actuation direction arrow A acts to fluidly seal off first the orifice 14 and, with additional translation, the output port 28. The motor 12 may be controlled by a microprocessor 32. The microprocessor 32 may be in communication with one or more sensors 34, the sensors 34 providing input to the microprocessor 32 for use in determining the need for the delivery of fluid 31 from the output port 28.

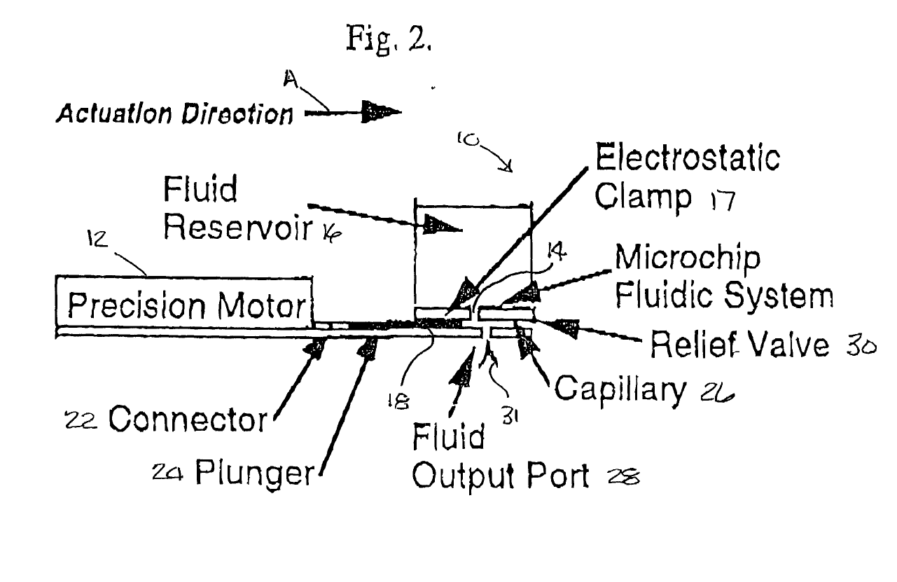

The precision actuator 12 can be implemented in several configurations. One version is a piezoelectric stepper motor such as that disclosed by Judy, et al.¹, enclosed and incorporated herein by reference; a second is a solenoid motor operating on electromagnetic actuation principles; a third type of motor operates by electrostatic forces; a fourth version is based on thermal actuation mechanisms including those using shape-memory effects; a fifth includes the use of pneumatic actuation methods. Other small or miniature actuators or motors might also accomplish the same objectives and comprise the precision actuator 12. In general, these motors 12 may have micrometer or even sub-micrometer resolution with the appropriately controlled electrical inputs. One preferred embodiment includes all fluidics and micromotors fabricated on a single semiconductor substrate, as shown in FIG. 2. ¹ J. W. Judy, D. L. Polla, and W. P. Robbins, “A linear Piezoelectric Stepper Motor with Sub-Micrometer Displacement and Centimeter Travel”, IEEE Trans. on Ultrasonics, Ferroelectric, and Frequency Control, UFFC-37, 428437, 1990.

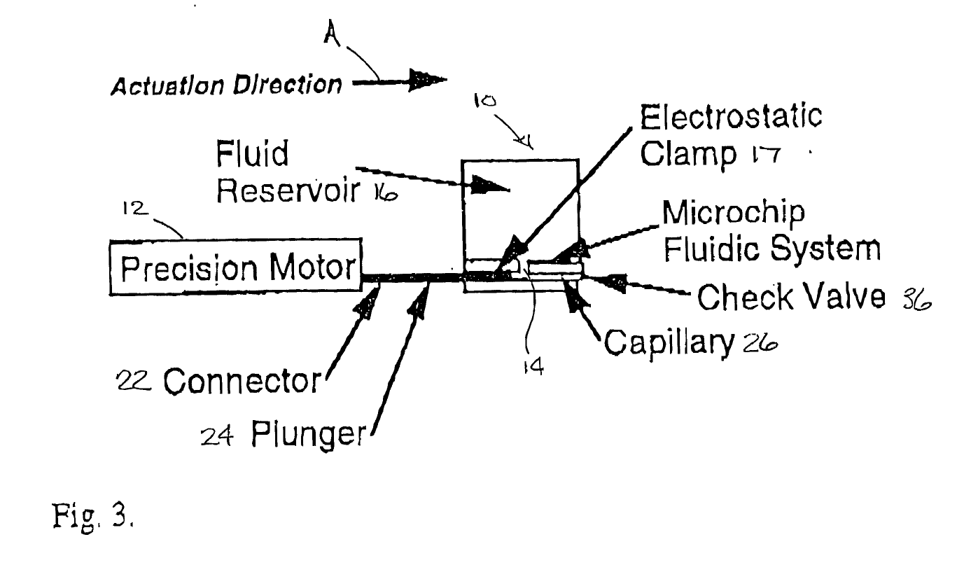

Referring to FIG. 3, a further technical approach concerns the use of a precision actuator with a microchip based fluidic management system 10. In this device a precision actuator or motor 12 similar to any of those discussed above is used to move a plunger 24 or push-rod through a confined capillary 26. This implements a fluid pushing, ejection, or pumping action demanding on the electronic input to the motor 12. The capillary 26 is formed integral to a silicon wafer(s) (or other substrates in which precision patterning can be accomplished) and may contain an attached adhesively-glued, anodically-bonded, or direct-bonded cover material comprising a check valve 36. The check valve 36 may be formed of another silicon wafer surface or surface from another material.

Directed movement of the plunger 24 or push-rod through the capillary 26 expels a liquid or gas from the reservoir 16 in a precisely metered manner from the check valve 36. Such volumes of fluid displaced can be on the order of picoliters and may be as large as several milliliters. By moving the plunger 24 or push-rod back-and-forth about a fluid delivery opening 14, liquid replenishing can be accomplished and arbitrarily large volumes of liquids can be directed to a specific site.

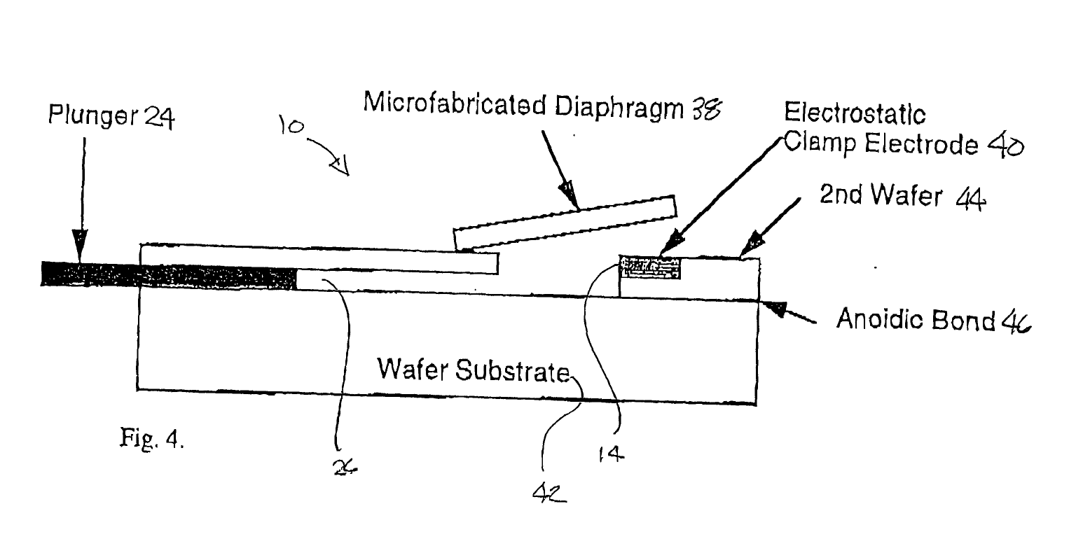

A third technical approach, depicted in FIG. 4, used here is the combined use of a microfabricated capillary operating in conjunction with microvalves, micropumps, fluid reservoirs, onchip microsensors, and other on-chip actuation structures or devices. One attractive feature of this system is the implementation of a passive valving system. Specifically, the directed force of the fluidically-coupled plunger 24, coupled to a motor 12, as previously described, is used to force-open or force close an orifice 14 covered by a microfabricated diaphragm 38 or cantilever flap. This passive valving system prevents the unwanted seepage of liquids into the active fluid pathway of the fluidics control system while allowing fluid to be dispensed in a desired single direction. Although there are many examples of microfabricated valves, many based on thin film deposition technology, a generic implementation is shown.

A unique feature is the incorporation of an electrostatic holding clamp 40 to firmly immobilize the valve (diaphragm 38) in the shut position. The capillary 26 is formed on a first substrate 42. A second substrate 44, having the clamp electrode 40 formed therein, is bonded to the first substrate 42, preferably by an anodic bond 46.

Although several implementations are possible, all the components can be integrated together and sealed within a hermetic can such as that made out of titanium for implantation within a human body. Re-filling multiple reservoirs can be carried out through conventional septum methods.

What is claimed is:

1. A precision controller of the movement of at least a first fluid, comprising:
a precision motor;
valve means operably coupled to the precision motor;
orifice means being fluidly coupled to a source of fluid and to the valve means, whereby actuation of the valve means by the precision motor acts to selectively expose and cover the orifice to implement fluid valving.
